(19) United States
(12) Patent Application Publication
(10) Pub. No.: US 2009/0149582 A1
(43) Pub. Date: Jun. 11, 2009

(54) SELF-EXTINGUISHING THERMOPLASTIC POLYURETHANES, THEIR USE, AND PROCESSES FOR THEIR PREPARATION

(75) Inventors: Henricus Peerlings, Solingen (DE); Juergen Winkler, Langenfeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/328,395

(22) Filed: Dec. 4, 2008

(30) Foreign Application Priority Data
Dec. 5, 2007 (DE) 102007058435.2

(51) Int. Cl. C08K 5/3492

(52) U.S. Cl. 524/101

(57) ABSTRACT

The present invention relates to self-extinguishing thermoplastic polyurethanes, a process for their preparation and their use.

### RELATED APPLICATIONS

This application claims benefit to German Patent Application No. 10 2007 058 435.2, filed Dec. 5, 2007, which is incorporated herein by reference in its entirety for all useful purposes.

### BACKGROUND OF THE INVENTION

The present invention relates to self-extinguishing thermoplastic polyurethanes, a process for their preparation and their use.

Thermoplastic polyurethanes (TPU) are of great industrial importance because of their good elastomer properties and thermoplastic processability. An overview of the preparation, properties and uses of TPU is given e.g. in Kunststoff Handbuch [G. Becker, D. Braun], volume 7 “Polyurethane”, Munich, Vienna, Carl Hanser Verlag, 1983.

TPU are usually built up from linear polyols (macrodiols), such as polyester, polyether or polycarbonate diols, organic diisocyanates and short-chain, usually difunctional alcohols (chain lengtheners). They can be prepared continuously or discontinuously. The best-known preparation processes are the belt process (GB-A 1 057 018) and the extruder process (DE-A 19 64 834).

Thermoplastically processable polyurethane elastomers can be built up either stepwise (prepolymer metering process) or by simultaneous reaction of all the components in one stage (one-shot metering process).

A disadvantage of TPU is their easy flammability. To reduce this disadvantage, flameproofing agents, such as, for example, halogen-containing compounds, are incorporated into the TPU. However, the addition of these products often has an adverse effect on the mechanical properties of the TPU moulding compositions obtained. Halogen-free self-extinguishing TPU moulding compositions are also worth aiming for because of the corrosive action of the halogen-containing substances.

EP-B 0 617 079 describes the use of a combination of a phosphate and/or phosphonate with melamine cyanurate. Above all, the distribution of this high-melting filler in the polymer matrix is not trivial. Furthermore, in spite of the high filler content, the burning properties are often not adequate.

U.S. Pat. No. 5,110,850 describes the use of melamine. A very large amount of melamine must be added, and nevertheless the burning properties are not adequate.

Above all, when the TPU is employed in the electrical/electronics sector, in particular in cables, the requirements on the burning properties are very high. Furthermore, in cables readily combustible, non-flameproofed polyolefin (e.g. polypropylene) is often employed in the sheathing, as a result of which in addition to its own flame resistance, the task of likewise extinguishing this polyolefin falls to the TPU. These high requirements on the burning properties with simultaneously thin wall thickness of the TPU sheathing and good extrudability are not met by the known TPU materials.

The object of the present invention was therefore to provide self-extinguishing thermoplastic polyurethanes which, as cable sheathing material, contain no halogen-containing flameproofing agents, extinguish in a few seconds after ignition with a hot flame and do not drip or form burning drips.

It has been possible to achieve this object in that for the flameproofing, the TPU contains a mixture of melamine and melamine cyanurate and optionally additional flameproofing agents.

### EMBODIMENTS OF THE INVENTION

An embodiment of the present invention is a thermoplastic polyurethane based on
a) an organic and/or modified organic diisocyanate;
b) a polyhydroxy compound;
c) a chain-lengthening agent;
d) a flameproofing agent;
and optionally
e) a catalyst;
f) a chain terminator; and
g) an auxiliary substance and/or additive;,
wherein said flameproofing agent comprises melamine cyanurate and melamine and optionally comprises at least one additional flameproofing agent.

Another embodiment of the present invention is the above thermoplastic polyurethane, wherein said polyhydroxy compound is a substantially difunctional polyhydroxy compound.

Yet another embodiment of the present invention is a process for preparing the above thermoplastic polyurethane, comprising reacting
A) an organic and/or modified organic diisocyanate (a);
B) a polyhydroxy compound (b); and
C) a chain-lengthening agent (c);
   in the presence of
D) a flameproofing agent (d)
   and optionally
E) a catalyst (e),
F) a chain terminator (f), and
G) an auxiliary substance and/or additive (g)
   wherein said flameproofing agent comprises melamine cyanurate and melamine and optionally comprises at least one additional flameproofing agent.

Another embodiment of the present invention is the above process, wherein said polyhydroxy compound is a substantially difunctional polyhydroxy compound.

Yet another embodiment of the present invention is an injection-moulded article comprising the above thermoplastic polyurethane.

Yet another embodiment of the present invention is an extruded article comprising the above thermoplastic polyurethane.

### DESCRIPTION OF THE INVENTION

The invention therefore provides self-extinguishing thermoplastic polyurethanes which are obtainable from
a) organic and/or modified organic diisocyanates
   with
b) polyhydroxy compounds, in particular substantially difunctional polyhydroxy compounds
   and
c) chain-lengthening agents
   in the presence of
d) flameproofing agents
   and optionally
e) catalysts
f) chain terminators
g) auxiliary substances and/or additives,
   wherein melamine cyanurate and melamine and optionally additional other flameproofing agents are employed as the flameproofing agents.

The invention also provides a process for the preparation of the self-extinguishing thermoplastic polyurethanes according to the invention, wherein
A) organic and/or modified organic diisocyanates (a)
   are reacted with
B) polyhydroxy compounds (b), in particular substantially difunctional polyhydroxy compounds
   and
C) chain-lengthening agents (c)
   in the presence of
D) flameproofing agents (d)
   and optionally
E) a catalysts (e),
F) chain terminators (f),
G) auxiliary substances and/or additives (g)
   wherein melamine and melamine cyanurate and optionally additional other flameproofing agents are employed as the flameproofing agents (d).

The melamine and the melamine cyanurate can optionally also be added subsequently to the finished TPU via a compounding.

The thermoplastic polyurethanes (also called TPU for short) are substantially linear thermoplastically processable polyurethanes.

It was surprising and in no way foreseeable that it was possible to obtain self-extinguishing TPU moulding compositions by the use of a combination of melamine and melamine cyanurate.

All TPU which are known per se and can be prepared by conventional processes are suitable in principle for the “flameproofing” according to the invention.

The TPU are preferably built up from the following components:

Organic diisocyanates (a) which can be used are aliphatic, cycloaliphatic, araliphatic, aromatic and heterocyclic diisocyanates or any desired mixtures of these diisocyanates (cf. HOUBEN-WEYL “Methoden der organischen Chemie”, volume E20 “Makromolekulare Stoffe”, Georg Thieme Verlag, Stuttgart, New York 1987, p. 1587-1593 or Justus Liebigs Annalen der Chemie, 562, pages 75 to 136).

There may be mentioned specifically by way of example: aliphatic diisocyanates, such as ethylene-diisocyanate, 1,4-tetramethylene-diisocyanate, 1,6-hexamethylene-diisocyanate and 1,12-dodecane-diisocyanate; cycloaliphatic diisocyanates, such as isophorone-diisocyanate, 1,4-cyclohexane-diisocyanate, 1-methyl-2,4-cyclohexane-diisocyanate and 1-methyl-2,6-cyclohexane-diisocyanate and the corresponding isomer mixtures, and 4,4′-dicyclohexylmethane-diisocyanate, 2,4′-dicyclohexylmethane-diisocyanate and 2,2′-dicyclohexylmethane-diisocyanate and the corresponding isomer mixtures; and moreover aromatic diisocyanates, such as 2,4-toluylene-diisocyanate, mixtures of 2,4-toluylene-diisocyanate and 2,6-toluylene-diisocyanate, 4,4′-diphenylmethane-diisocyanate, 2,4′-diphenylmethane-diisocyanate and 2,2′-diphenylmethane-diisocyanate, mixtures of 2,4′-diphenylmethane-diisocyanate and 4,4′-diphenylmethane-diisocyanate, urethane-modified liquid 4,4′-diphenylmethane-diisocyanates or 2,4′-diphenylmethane-diisocyanates, 4,4′-diisocyanato-1,2-diphenylethane and 1,5-naphthylene-diisocyanate. 1,6-Hexamethylene-diisocyanate, 1,4-cyclohexane-diisocyanate, isophorone-diisocyanate, dicyclohexylmethane-diisocyanate, diphenylmethane-diisocyanate isomer mixtures having a 4,4′-diphenylmethane-diisocyanate content of more than 96 wt. % and in particular 4,4′-diphenylmethane-diisocyanate and 1,5-naphthylene-diisocyanate are preferably used. The diisocyanates mentioned can be used individually or in the form of mixtures with one another. They can also be used together with up to 15 mol % (calculated as total diisocyanate) of a polyisocyanate, but polyisocyanate should be added at most in an amount such that a product which is still thermoplastically processable is formed. Examples of polyisocyanates are triphenylmethane-4,4′,4″-triisocyanate and polyphenyl-polymethylene-polyisocyanates.

Polyhydroxy compounds or polyols (b) are those having on average at least 1.8 to at most 3.0 zerewitinoff-active hydrogen atoms and a number-average molecular weight M̅ₙ of from 450 to 10,000, preferably from 450 to 6,000. Due to their production, these often contain small amounts of non-linear compounds. “Substantially linear polyols” are therefore also often referred to. Polyester, polyether, polycarbonate diols or mixtures of these are preferred.

Suitable polyether diols can be prepared by reacting one or more alkylene oxides having 2 to 4 carbon atoms in the alkylene radical with a starter molecule which contains two bonded active hydrogen atoms. Alkylene oxides which may be mentioned are e.g.: ethylene oxide, 1,2-propylene oxide, epichlorohydrin and 1,2-butylene oxide and 2,3-butylene oxide. Ethylene oxide, propylene oxide and mixtures of 1,2-propylene oxide and ethylene oxide are preferably used. The alkylene oxides can be used individually, alternately in succession or as mixtures. Possible starter molecules are, for example: water, amino alcohols, such as N-alkyl-diethanolamines, for example N-methyl-diethanolamine, and diols, such as ethylene glycol, 1,3-propylene glycol, 1,4-butanediol and 1,6-hexanediol. Mixtures of starter molecules can also optionally be employed. Suitable polyetherols are furthermore the polymerization products of tetrahydrofuran which contain hydroxyl groups. Trifunctional polyethers can also be employed in proportions of from 0 to 30 wt. %, based on the bifunctional polyethers, but at most in an amount such that a product which is still thermoplastically processable is formed. The substantially linear polyether diols preferably have number-average molecular weights M̅ₙ of from 450 to 6,000. They can be used either individually or in the form of mixtures with one another

Suitable polyester diols can be prepared, for example, from dicarboxylic acids having 2 to 12 carbon atoms, preferably 4 to 6 carbon atoms, and polyhydric alcohols. Possible dicarboxylic acids are, for example: aliphatic dicarboxylic acids, such as succinic acid, glutaric acid, adipic acid, subetic acid, azelaic acid and sebacic acid, or aromatic dicarboxylic acids, such as phthalic acid, isophthalic acid and terephthalic acid. The dicarboxylic acids can be used individually or as mixtures, e.g. in the form of a succinic, glutaric and adipic acid mixture. For preparation of the polyester diols it may be advantageous, where appropriate, to use the corresponding dicarboxylic acid derivatives, such as carboxylic acid diesters having 1 to 4 carbon atoms in the alcohol radical, carboxylic acid anhydrides or carboxylic acid chlorides, instead of the dicarboxylic acids. Examples of polyhydric alcohols are glycols having 2 to 10, preferably 2 to 6 carbon atoms, e.g. ethylene glycol, diethylene glycol, 1,4-butanediol, 1,5-pentanediol 1,6-hexanediol, 1,10-decanediol, 2,2-dimethyl-1,3-propanediol, 1,3-propanediol or dipropylene glycol. The polyhydric alcohols can be used by themselves or in a mixture with one another, depending on the desired properties. Esters of carbonic acid with the diols mentioned, in particular those having 4 to 6 carbon atoms, such as 1,4-butanediol or 1,6-hexanediol, condensation products of ω-hydroxycarboxylic acids, such as ω-hydroxycaproic acid, or polymerization products of lactones, e.g. optionally substituted ω-caprolactones, are furthermore suitable. Ethanediol polyadipates, 1,4-butanediol polyadipates, ethanediol 1,4-butanediol polyadipates, 1,6-hexanediol neopentylglycol polyadipates, 1,6-hexanediol 1,4-butanediol polyadipates and polycaprolactones are preferably used as polyester diols. The polyester diols have number-average molecular weights M̅ₙ of from 450 to 10,000 and can be used individually or in the form of mixtures with one another.

Chain-lengthening agents (c) have on average 1.8 to 3.0 zerewitinoff-active hydrogen atoms and have a molecular weight of from 60 to 400. In addition to compounds containing amino groups, thiol groups or carboxyl groups, these are understood as meaning those having two to three, preferably two hydroxyl groups.

Aliphatic diols having 2 to 14 carbon atoms are preferably employed as chain-lengthening agents, such as e.g. ethanediol, 1,2-propanediol, 1,3-propanediol, 1,4-butanediol, 2,3-butanediol, 1,5-pentanediol, 1,6-hexanediol, diethylene glycol and dipropylene glycol, However, diesters of terephthalic acid with glycols having 2 to 4 carbon atoms, e.g. terephthalic acid bis-ethylene glycol or terephthalic acid bis-1,4-butanediol, hydroxyalkylene ethers of hydroquinone, e.g. 1,4-di(β-hydroxyethyl)-hydroquinone, ethoxylated bisphenols, e.g. 1,4-di(β-hydroxyethyl)-bisphenol A, (cyclo)aliphatic diamines, such as isophoronediamine, ethylenediamine, 1,2-propylenediamine, 1,3-propylenediamine, N-methyl-propylene-1,3-diamine and N,N′-dimethylethylenediamine, and aromatic diamines, such as 2,4-toluylenediamine, 2,6-toluylenediamine, 3,5-diethyl-2,4-toluylenediamine or 3,5-diethyl-2,6-toluylenediamine or primary mono-, di-, tri- or tetraalkyl-substituted 4,4′-diaminodiphenylmethanes, are also suitable. Ethanediol, 1,4-butanediol, 1,6-hexanediol, 1,4-di(β-hydroxyethyl)-hydroquinone or 1,4-di(β-hydroxyethyl)-bisphenol A are particularly preferably used as chain lengtheners. Mixtures of the abovementioned chain lengtheners can also be employed. In addition, relatively small amounts of triols can also be added.

According to the invention, a mixture of melamine and melamine cyanurate is employed as the flameproofing agents (d). Melamine and melamine cyanurate can be employed in the commercially available form.

The total amount of melamine and melamine cyanurate is preferably between 10 and 60 wt. %, particularly preferably 15 to 50 wt. %, based on the total amount of TPU. The weight ratio between melamine and melamine cyanurate is between 30:1 to 1:30, preferably 10:1 to 1:10.

Additional flameproofing agents (excluding melamine and melamine cyanurate) can optionally also be employed, such as e.g. phosphates and/or phosphonates. For an overview see e.g. H. Zweifel, Plastics Additives Handbook, 5th Ed., Hanser Verlag Munich, 2001, Chapter 12; J. Green, J. of Fire Sciences, 1997, 15, p. 52-67 or Kirk-Othmer Encyclopedia of Chemical Technology, 4th Ed., Vol. 10, John Wiley & Sons, New York, p. 930-998. Flameproofing agents which can be built in can likewise be employed as additional flameproofing agents, as described e.g. in U.S. Pat. No. 7,160,974.

Suitable catalysts (e) are the conventional tertiary amines known from the prior art, such as e.g. triethylamine, dimethylcyclohexylamine, N-methylmorpholine, N,N′-dimethylpiperazine, 2-(dimethylamino-ethoxy)ethanol, diazabicyclo[2,2,2]octane and the like, and, in particular, organometallic compounds, such as titanic acid esters, iron compounds, bismuth compounds or tin compounds, such as tin diacetate, tin dioctoate, tin dilaurate or the tin dialkyl salts of aliphatic carboxylic acids, such as dibutyltin diacetate or dibutyltin dilaurate or similar. Preferred catalysts are organometallic compounds, in particular titanic acid esters and iron, bismuth and tin compounds. The total amount of catalysts in the TPU according to the invention is as a rule about 0 to 5 wt. %, preferably 0 to 2 wt. %, based on the total amount of TPU.

Compounds (f) which are monofunctional with respect to isocyanates can be employed as so-called chain terminators in proportions of up to 2 wt. %, based on the TPU. Suitable compounds are e.g. monoamines, such as butyl- and dibutylamine, octylamine, stearylamine, N-methylstearylamine, pyrrolidine, piperidine or cyclohexylamine, and monoalcohols, such as butanol, 2-ethylhexanol, octanol, dodecanol, stearyl alcohol, the various amyl alcohols, cyclohexanol and ethylene glycol monomethyl ether.

The thermoplastic polyurethane elastomers according to the invention can contain auxiliary substances and additives (g) in amounts of up to a maximum of 20 wt. %, based on the total amount of TPU. Typical auxiliary substances and additives are lubricants and mould release agents, such as fatty acid esters, metal soaps thereof, fatty acid amides, fatty acid ester-amides and silicone compounds, antiblocking agents, inhibitors, stabilizers against hydrolysis, light, heat and discoloration, dyestuffs, pigments, inorganic and/or organic fillers, plasticizers, such as phosphates, phthalates, adipates, sebacates and alkylsulfonic acid esters, fungistatically and bacteriostatically acting substances as well as fillers and mixtures thereof and reinforcing agents. Reinforcing agents are, in particular, fibrous reinforcing substances, such as e.g. inorganic fibres which are prepared according to the prior art and can also be charged with a size. More detailed information on the auxiliary substances and additives mentioned is to be found in the technical literature, for example the monograph by J. H. Saunders and K. C. Frisch “High Polymers”, volume XVI, Polyurethane, part 1 and 2, Verlag Interscience Publishers 1962 and 1964, the Taschenbuch für Kunststoff-Additive by R. Gächter and H. Müller (Hanser Verlag Munich 1990) or DE-A 29 01 774.

For the preparation of the TPU according to the invention, the builder components (a), (b), (c) and optionally (f) are reacted in the presence of the flameproofing agents (d) according to the invention and optionally the catalysts (e) and the auxiliary substances and/or additives (g) in amounts such that the ratio of equivalents of NCO groups of the diisocyanates (a) to the sum of the components (b), (c), (d) and (f) containing zerewitinoff-active hydrogen atoms is 0.9:1 to 1.1:1. If a flameproofing agent which can be built in is used under (d), this is in all cases present during the reaction of the builder components (a), (b) and (c), while the melamine and melamine cyanurate can also be added subsequently to the TPU.

The TPU moulding compositions according to the invention are self-extinguishing, do not drip and do not form burning drips.

The TPU according to the invention can optionally be worked further, e.g. by conditioning of the TPU for the production of sheets or blocks, by comminution or granulation in shredders or mills, by devolatilization and granulation with melting.

The TPU is preferably passed through a unit for continuous devolatilization and extrudate formation. This unit can be e.g. a multi-screw extruder (TSE)

The TPU according to the invention are preferably employed for the production of injection-moulded articles and extruded articles, in particular for cable sheathing.

The invention is to be explained in more details with the aid of the following examples.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

Abbreviations used in the following:

| | |
|---|---|
| Terathane ® 1000 | Polyether having a molecular weight of Mₙ= |
| | 1,000 g/mol; product from Du Pont de Nemours |
| MDI | Methylene-4,4′-(phenyl-diisocyanate), |
| | Desmodur ® 44 M from Bayer MaterialScience |
| | AG |
| BDO | 1,4-Butanediol |
| Irganox ® 1010 | Tetrakis(methylene-(3,5-di-tert-butyl-4- |
| | hydroxycinnamate))- methane, product from |
| | Ciba Specialty Chemicals Inc. |
| Licowax ® C | Release agent from Clariant Wurtz GmbH |
| MC | Melamine cyanurate, flameproofing agent |
| M | Melamine, flameproofing agent |
| BDP | Bisphenol A diphenyl phosphate, oligomeric |
| | mixture, flameproofing agent |
| IHPO | Isobutyl-bis(hydroxypropyl)-phosphine oxide, |
| | flameproofing agent |

Preparation of TPU-A (with IHPO and BDP)

Terathane® 1000 (650 g/min) which contained BDP (10 wt. %, based on the total amount of TPU), Irganox® 1010 (0.4 wt. %, based on the total amount of TPU) and tin dioctoate (100 ppm, based on the amount of Terathane® 1000) was heated to 180° C. and metered continuously by means of a gear pump into the first housing of a ZSK 53 (twin-screw extruder from Werner&Pfleiderer).

Butanediol (98 g/min) and IHPO (51 g/min; 60° C., 4 wt. %, based on the total amount of TPU) were metered continuously into the same housing together with Licowax® C (5 g/min; 0.4 wt. %, based on the total amount of TPU).

Desmodur® 44 M (461 g/min) was then metered continuously into housing 3.

Housings 1 to 3 of the extruder were heated to 80° C. and housings 4 to 8 were heated to 220 to 230° C., while the last 4 housings were cooled. The screw speed was 290 rpm.

At the end of the screw, the hot melt was taken off as a strand, cooled in a water bath and granulated.

TPU-A was used as the basis for Examples 1 to 4 in an amount of 75 wt %.

Preparation of TPU-B

A TPU having a Shore A hardness of 92 was prepared. For this, a mixture of 1,000 g of Terathane® 1000, 180 g of BDO, 7 g of Irganox® 1010 and 4 g of Licowax® C was heated to 180° C. with 50 ppm of tin dioctoate (based on the amount of Terathane® 1000) while stirring with a blade stirrer at a speed of 500 revolutions per minute (rpm). Thereafter, 745 g of TPU were added. The mixture was then stirred for 110 seconds and the TPU was poured out. Finally, the material was after-treated at 80° C. for 30 min. The finished TPU was cut, granulated and further processed.

TPU-B was used as the basis for Examples 5 to 7 an amount of 64.5 wt. %.

Extrusion

Single-Screw Extruder:

The TPU granules were melted (metering 3 kg/h; temperature 230 to 195° C.) in a single-screw extruder 30/25D (Plasticorder PL 2000-6 from Brabender) with the addition of melamine cyanurate and/or melamine (for the amounts see Table 1) and then processed to granules using a strand granulator (Examples 1 and 2).

Twin-Screw Extruder (TSE):

Melamine and/or melamine cyanurate (for the amounts see Table 1) were added to the TPU granules prepared. Extrusion was carried out on an extruder of the type DSE 25, 4 Z, 360 Nm, which has the following construction:
1. cold intake zone with conveying elements,
2. first heating zone (175° C.) with first kneading zone,
3. second heating zone (185° C.) with conveying element and second kneading zone,
4. third heating zone (190° C.) with kneading zone, conveying element and vacuum devolatilization
5. crosshead (195° C.) and die (190° C.) with a delivery of 10 kg/h at a speed of 220 rpm and the extrudate was then worked up to granules with a strand granulator (Examples 3 to 7).

### Determination of the Flameproofing Properties

The flameproofing properties were determined in accordance with UL94 V at a thickness of the test specimen of 3 mm (described in Underwriters Laboratories Inc. Standard of Safety, “Test for Flammability of Plastic Materials for Parts in Devices and Appliances”, p. 14 et seq., Northbrook 1998 and J. Triotzsch, “International Plastics Flammability Handbook”, p. 346 et seq., Hanser Verlag, Munich 1990).

In this test, a V-0 rating denotes non-burning dripping with after-burning times of less than 10 s. A product with this rating is therefore described as flame resistant. A V-2 rating denotes an after-burning time of less than 30 s and ignition of the wadding and denotes an inadequate flame resistance. Failed means that the sample has still longer after-burning times.

TABLE 1

| | | | | | Incorporation | | |
|---|---|---|---|---|---|---|---|
| | Formulation | | | | of MC/M | | |
| | MC | | BDP | | Single- | | |
| | [wt. | M | [wt. | IHPO | screw | | |
| Example | %] | [wt. %] | %] | [wt. %] | extruder | TSE | UL 94 |
| 1 | 25 | 0 | 7.5 | 3 | not | | |
| (comparison) | | | | | possible | | |
| 2 | 18 | 7 | 7.5 | 3 | X | | V-0 |
| 3 | 25 | 0 | 7.5 | 3 | | X | V-2 |
| (comparison) | | | | | | | |
| 4 | 18 | 7 | 7.5 | 3 | | X | V-0 |
| 5 | 35.5 | 0 | 0 | 0 | | X | V-2 |
| (comparison) | | | | | | | |
| 6 | 25.5 | 10 | 0 | 0 | | X | V-0 |
| 7 | 0 | 35.5 | 0 | 0 | | X | failed |
| (comparison) | | | | | | | |

All the examples contain flameproofing agents in a total amount of 35.5 wt. %.

In Comparison Example 1, TPU-A was taken and extruded with 25 wt. % of MC by means of a single-screw extruder. Incorporation of the MC was not possible, and therefore no flameproofing properties could be determined.

In Example 2 according to the invention, TPU-A was extruded with 18 wt. % of MC and 7 wt. % of M via a single-screw extruder. In contrast to Comparison Example 1, incorporation was possible; the burning test gave V-0.

Comparison Example 3 describes the extrusion of TPU-A with 25 wt. % of MC by means of a TSE, incorporation being possible, but the burning test gave a rating of only V-2.

Example 4 according to the invention describes the extrusion of TPU-A with 18 wt. % of MC and 7 wt. % of M. Incorporation was possible. The burning test gave V-0.

In Comparison Examples 5 and 7, TPU-B, which contained no further flameproofing agent was extruded with 35.5 wt. % of MC (Ex. 5) and, respectively, 35.5 wt. % of M (Ex. 7). Incorporation was possible. However, the burning properties were inadequate.

TPU-B with 25.5 wt. % of MC and 10 wt. % of M had very good burning properties and was very readily processable.

1. A thermoplastic polyurethane based on
h) an organic and/or modified organic diisocyanate;
i) a polyhydroxy compound;
j) a chain-lengthening agent;
k) a flameproofing agent;
and optionally
l) a catalyst;
m) a chain terminator; and
n) an auxiliary substance and/or additive;,
wherein said flameproofing agent comprises melamine cyanurate and melamine and optionally comprises at least one additional flameproofing agent.

2. The thermoplastic polyurethane of claim 1, wherein said polyhydroxy compound is a substantially difunctional polyhydroxy compound.

3. A process for preparing the thermoplastic polyurethane of claim 1, comprising reacting
B) an organic and/or modified organic diisocyanate (a);
B) a polyhydroxy compound (b); and
C) a chain-lengthening agent (c);
in the presence of
D) a flameproofing agent (d)
and optionally
E) a catalyst (e),
F) a chain terminator (f), and
G) an auxiliary substance and/or additive (g)
wherein said flameproofing agent comprises melamine cyanurate and melamine and optionally comprises at least one additional flameproofing agent.

4. The process of claim 3, wherein said polyhydroxy compound is a substantially difunctional polyhydroxy compound.

5. An injection-moulded article comprising the thermoplastic polyurethane of claim 1.

6. An extruded article comprising the thermoplastic polyurethane of claim 1.
